(19) United States
(12) Patent Application Publication
(10) Pub. No.: US 2007/0020475 A1
(43) Pub. Date: Jan. 25, 2007

(54) Primed substrate and method for making the same

(76) Inventors: Kendall W. Prince, Layton, UT (US); Matt A. Stott, Syracuse, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/190,037

(22) Filed: Jul. 21, 2005

(51) Int. Cl. B05D 3/00; B32B 21/04

(52) U.S. Cl. 428/537.1; 427/299

(57) ABSTRACT

A substrate primed to receive a coat of paint or other decoration and a method for producing the same. A substrate is primed with a viscous coating material having sixty to ninety-five percent solid material by mass to fill surface pores and cover the substrate surface with a dense layer of coating material such that a single coat of paint provides a consistent rich color and luster throughout.

### BACKGROUND OF THE INVENTION

1. Field of the Invention

The present invention relates to a method for preparing a substrate to receive a decoration and, more particularly, to a method for priming a porous substrate to reduce the time and expense traditionally associated with finishing the surface of a substrate.

2. Background and Related Art

Proper preparation of a surface to be painted or otherwise decorated is key to obtaining an aesthetically pleasing, long-lasting result. Standard surface preparatory procedures include applying a primer to a surface that has been filled and sanded to conceal interruptions to a continuous surface structure, including surface voids and various imperfections. Priming helps to seal the surface and eliminate lap marks, dry patches and flaking. As primer tends to be more dilute than topcoat paint, primer easily absorbs into and conceals surface pores. A subsequently applied topcoat may thus demonstrate smooth and consistent color and luster.

In addition to its use in preparing a wall or ceiling surface to receive a decoration such as a coat of paint, a primer may be used in connection with almost any type of woodwork, including crown molding, baseboards, window frames, doors, chair rails, mantles and staircase railings. Although traditionally such products were made of solid wood, consumers have recognized and taken advantage of reduced costs associated with solid wood substitutes such as finger-jointed wood, plywood, particle board, medium density fiberboard (“MDF”), high density fiberboard (“HDF”), plastic/wood composites, and cement-board products. Indeed, products comprised of solid wood substitutes cost less and require less labor to produce than their solid wood counterparts due to their relatively light weight and density. These qualities render the solid wood substitute products easy to transport, handle and install.

Despite the economic benefit associated with solid wood substitutes, however, solid wood products remain in high demand due to their aesthetic appeal. Indeed, although both a solid wood product and a product comprising solid wood substitute may undergo the same surface preparation and paint process, the finished solid wood product may appear more smooth and glossy than the finished solid wood substitute since the uninterrupted surface structure of solid wood effectively creates a smooth, relatively impervious surface even before primer is applied. Solid wood substitutes do not possess this smooth or uninterrupted surface structure of solid wood. Application of primer to solid wood thus acts as a first coat of paint, creating an opaque surface from which a topcoat may garner a rich, opulent appearance. Primer applied to a solid wood substitute, on the other hand, is often absorbed into the pores or similar surface interruptions of the product. A subsequently applied coat of paint may thus appear somewhat translucent if not followed by a second topcoat.

Accordingly, what is needed is a method for priming a substrate that lacks an uninterrupted surface structure because of pores or similar imperfections to create a substantially uninterrupted and impervious surface such that a subsequently applied decoration such as a coat of paint garners a rich, opaque appearance comparable to a topcoat applied to primed solid wood. What is also needed is a method for priming such a substrate that creates an aesthetically appealing finished product at minimal expense. Further, what is needed is a method for priming such a substrate wherein the substrate may be primed prior to consumer purchase to facilitate implementation by those with a minimum of painting knowledge and experience.

The present invention overcomes the foregoing and other disadvantages of the prior art by providing a novel and improved primed substrate and method for producing the same.

### SUMMARY OF THE INVENTION

The present invention is a primed substrate and method for producing the same that is inexpensive and that facilitates an aesthetically pleasing, long-lasting finished product. Specifically, the substrate of the present invention comprises a rigid material, such as a molding for a window or door, comprising solid wood or a solid wood substitute. The substrate is coated with a viscous priming material thick enough to fill any discontinuities or pores in the surface of the substrate and to provide an opaque surface to cover the substrate. An excess of viscous priming material is removed such that the remaining priming material is substantially evenly distributed over a surface of the substrate. In certain embodiments, the substrate is guided through a priming device that both applies the viscous priming material and removes the excess. The primed substrate may then be coated with just one coat of paint or a similar decoration to result in a finished product having substantially consistent rich color and luster throughout. In this manner, the present invention avoids the expense and labor traditionally associated with purchasing and preparing a substrate for interior use.

These and other features and advantages of the present invention will be set forth or will become more fully apparent in the description that follows. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 is a perspective view of a primed substrate in accordance with certain embodiments of the present invention;

FIGS. 2A-B are cross-sectional views of alternative embodiments of a primed substrate in accordance with certain embodiments of the present invention;

FIGS. 2C-E are cross-sectional perspective views of alternative embodiments of a primed substrate in accordance with the present invention;

FIG. 3A is a perspective view of a coating element for priming a substrate in accordance with certain embodiments of the present invention;

FIG. 3B is a perspective view of a priming device for priming a substrate in accordance with certain embodiments of the present invention that incorporates the coating element of FIG. 3A;

FIG. 4 is a flow chart delineating steps for priming a substrate in accordance with certain embodiments of the present invention; and

FIG. 5 is a detailed flow chart outlining steps for applying a primer to a substrate in accordance with certain embodiments of the present invention.

### DETAILED DESCRIPTION OF THE INVENTION

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

As used in this specification, the term “primer” refers to a composition used to seal a surface before a decoration such as, but not limited to, a coat of paint is applied. The term “prime” refers to the process by which primer is applied to a surface. The term “solid wood” refers to a product comprised of unprocessed wood such as pine, redwood, red cedar, oak, fir, hemlock, spruce, mahogany, lauan and/or any other wood known to those in the art. The term “solid wood substitute,” or simply, “wood substitute,” refers to a substrate comprised of materials other than solid wood, including finger-jointed wood, plywood, particle board, light density fiberboard (“LDF”), medium density fiberboard (“MDF”), high density fiberboard (“HDF”), plastic/wood composites, cement board, flake board, wafer board, chip board, and/or any other solid wood substitute known to those in the art. The term “ultralite” refers to a light density fiberboard, or LDF. The term “cps” refers to centi-poise, the unit of measurement equal to 0.01 poise, which is the unit for absolute viscosity.

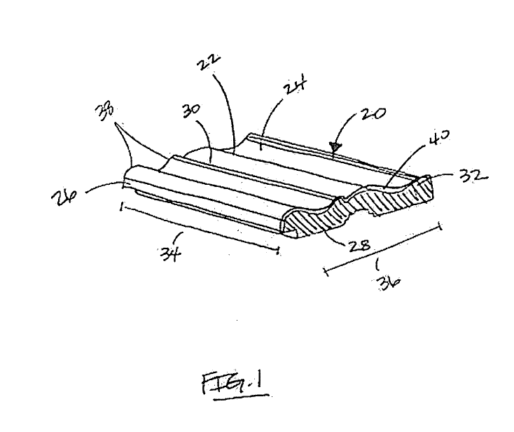

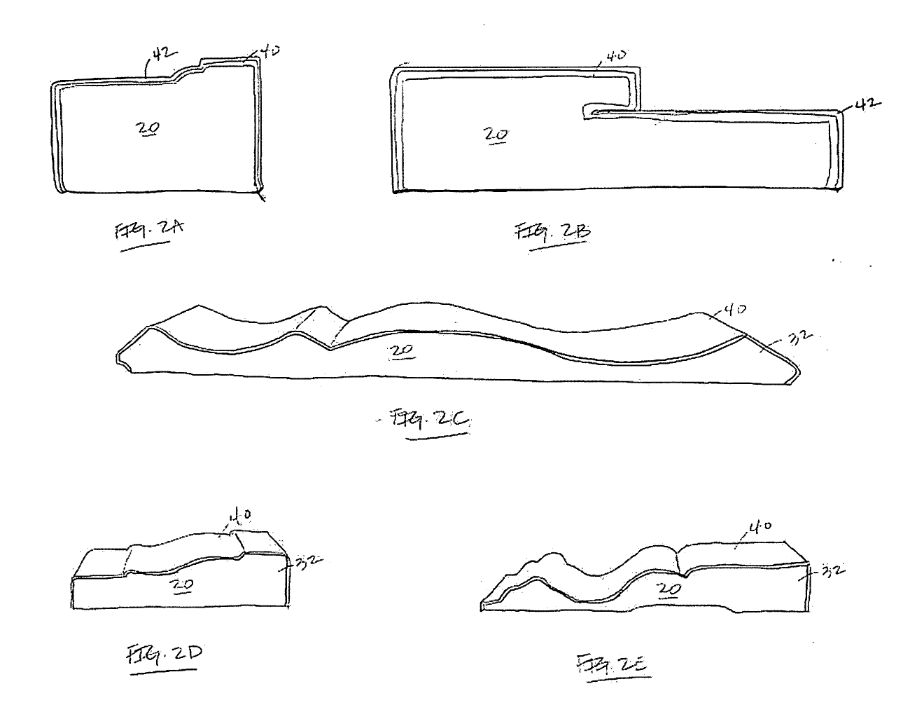

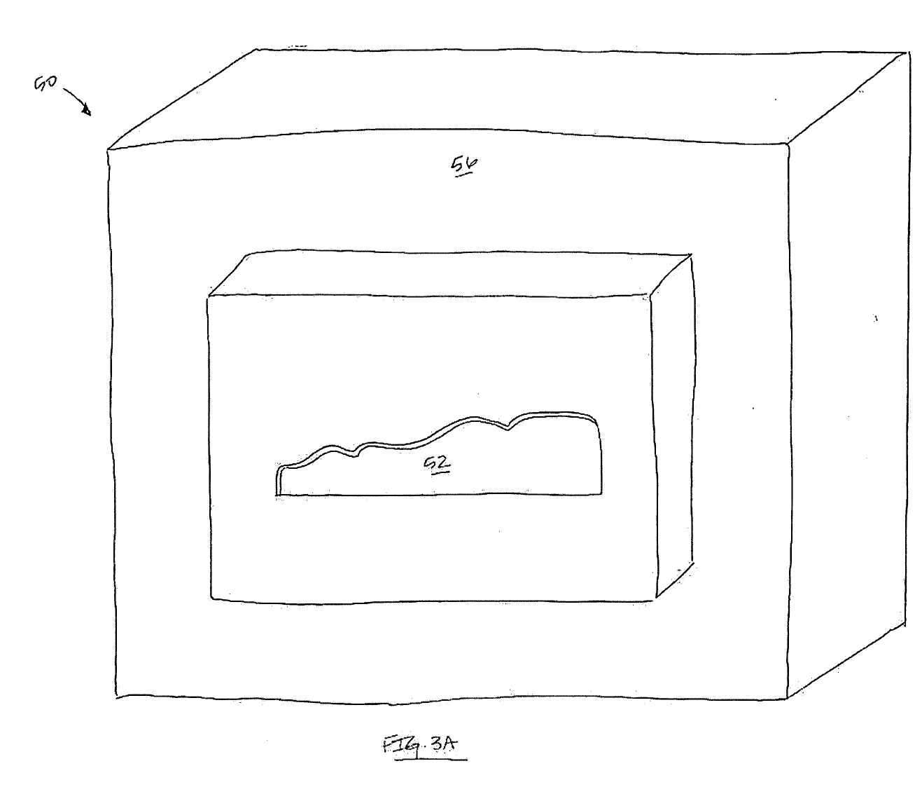

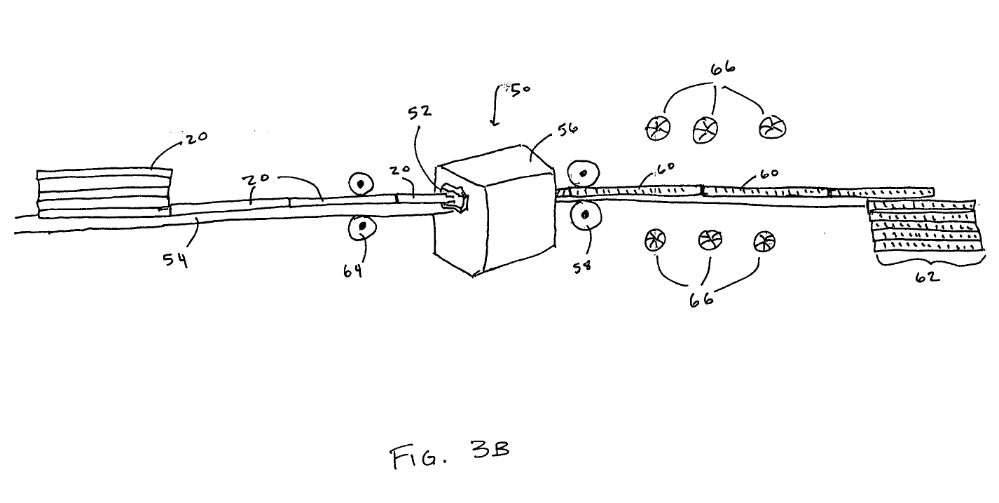

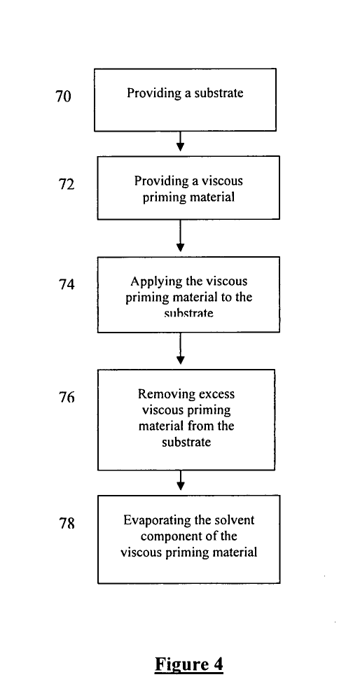

The present invention comprises a primed substrate and method for making the same. Referring to FIGS. 1 and 2A-E, a substrate 20 suitable for priming in accordance with the present invention is preferably rigid and may comprise solid wood, wood substitute, plastic, metal, or any other substantially rigid material known to those in the art. A substrate 20 may further comprise a length 34, a width 36, and a cross-sectional profile 32. According to certain embodiments of the present invention, a length 34 of the substrate 20 is substantially greater than its width 36, and a cross-sectional profile 32 is substantially uniform along such length 34 such that automated equipment may be easily implemented to facilitate priming the substrate 20, as discussed in more detail with reference to FIG. 3 below. A cross-sectional profile 32 may optionally incorporate ridges, dips, curves, geometric shapes, or any other contour 38 known to those in the art for purposes of enhancing the substrate's 20 aesthetic appeal. Such contours 38 may or may not be uniform along the width 36 of the substrate 20.

A substrate 20 may further comprise at least one decoratable surface 22, which may correspond to any portion of a top surface 24, sides 26, or a bottom surface 28. A decoratable surface 22 comprises any portion of the substrate intended for further processing after application of a primer, where such processing may include, without limitation, decoration by means of a texture, an embossed or inscribed design, a coat of paint, or any other aesthetically enhancing technique known to those in the art.

According to certain embodiments of the present invention, as illustrated in FIG. 1, a substrate 20 comprises a window molding having a decoratable surface 22 spanning its sides 26 and top surface 24. The top surface 24 incorporates several ridges, dips and curves to enhance the molding's aesthetic appeal. Both the top surface 24 and sides 26 are intended to eventually receive a coat of paint or similar decoration. The bottom surface 28 of the molding is adapted for attachment to a wall adjacent a window jamb.

A viscous priming material 40 may be applied to at least a portion of the decoratable surface 22 of the substrate 20 to facilitate an aesthetically pleasing, long lasting finished product. The viscous priming material 40 functions to fill any discontinuities or pores in the surface of the substrate and to render the decoratable surface 22 smooth, opaque, and ready to receive a finishing coat of paint or other means of decoration. More particularly, a viscous priming material 40 is sufficiently viscous to adequately prime, in a single coat, even a porous, lesser quality wood substitute such as MDF or ultralite.

Specifically, a viscosity of a viscous priming material 40 may comprise a range between about 1,000 and 350,000 cps. A viscous priming material 40 may further comprise a filler and a volatile component. Preferably, a filler comprises between sixty to ninety-five percent (60-95%) of the total composition by mass. A filler may comprise, for example, a cold-set product such as acetyl, acrylic, polyester, polycarbonate, polypropylene, polyethylene, polystyrene, polyurea, thermoplastic elastomers, vinyl alloys, synthetic resins such as urea formaldehyde, melamine formaldehyde, polyvinyl acetate, aliphatic resin glues, polyurethane glue, epoxy resins, other elastomeric material or combination thereof known to those in the art, lime, carbon black, talc, kolin, wood dust, fly ash, diatomaceous earth, or other like organic or inorganic materials. The volatile component may comprise acetone, alcohol, benzene, epichlorohydrin, esters, gasoline, glycol ethers, heptane, hexane, kerosene, ketones, methanol, methylene chloride, mineral spirits, naphtha, toluene, trichloroethane (methyl chloroform), turpentine, xylene, water, or any other carrier known to those in the art. A viscous priming material 40 may have a pH in a range between about 8.0 and 9.5. Preferably, a viscous priming material 40 in accordance with the present invention is water soluble and does not require a substantial amount of heat or pressure to set.

A viscous priming material 40 may optionally include additives such as pigments, scents, stabilizers, flame retardants, anti-oxidants, anti-fungals, or any other additives known to those in the art.

A priming device 50 may be provided to facilitate application of a viscous priming material 40 to a substrate 20 in accordance with the present invention. Referring now to FIGS. 3A and 3B, a priming device 50 may comprise a guide element 54 and a coating element 56. A guide element 54 may function to facilitate automatic or manual introduction of the substrate 20 into the coating element 56. According to certain embodiments of the present invention, entry rollers 64 may exert a limited, continuous pressure on lengths of substrate 20 biasing them towards coating element 56, such that a plurality of substantially rigid substrates 20 having a substantially similar cross-sectional profile 32 may be introduced in series, in a butt-fed manner, into the coating element 56.

The coating element 56 may include at least one opening 52 substantially corresponding to a cross-sectional profile 32 of the substrate 20. The substrate 20 may be introduced into the opening 52 of the coating element 56 and advanced therethrough by the action of exit rollers 58, which advance the primed substrate 60 through the priming device 50. A viscous priming material 40 may be applied as the substrate 20 advances. As the substrate exits the coating element 56, the opening 52 may function to remove any excess priming material 40 such that the resulting layer is uniform, consistent, and such that a cross-sectional profile 32 of the substrate 20 before priming substantially mirrors the cross-sectional profile 32 of the primed substrate 60 after priming.

In a preferred embodiment, the butt-fed lengths of substrate pass adjacent to one or more fans 66 that cause evaporation of the volatile component of the viscous priming material 40 that was applied by the priming device 50, leaving only the solid or filler component. In some embodiments of the present invention, numerous fans 66 are used over a course of ten to twenty feet to effectively evaporate the volatile component of the viscous priming material 40. Although performed in an ambient environment, the type of volatile component used and the type of filler used affect the time required to sufficiently evaporate the volatile component. After the volatile component is sufficiently evaporated from the viscous priming material 40 as deposited on the primed substrate 60 by the priming device 50, multiple primed substrates 60 can be placed in a stack 62 in various ways according to manufacturing needs, as is well known to those skilled in the art.

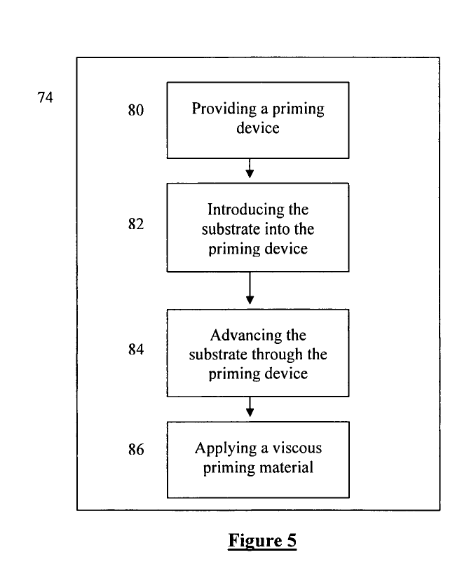

Referring now to FIG. 4, a method for priming a substrate in accordance with the present invention may comprise first providing a substrate 70. As discussed above with reference to FIGS. 1 and 2, a substrate 20 is preferably substantially rigid and uniform along a length thereof. Next, a method may comprise providing a viscous priming material 72. Preferably, the viscous priming material 40 comprises a viscosity sufficient to fill surface pores and imperfections, create a smooth, opaque surface, and reduce drying time, while remaining sufficiently fluid to facilitate easy application. A viscous priming material 40 also comprises a sufficient solid component—a cold-set filler component in a preferred embodiment—such that all of the volatile component can be evaporated from a primed substrate 60 within a reasonably brief time after the application of the viscous priming material 40, without the use of drying ovens or similar devices. In a preferred embodiment, the solid component of the viscous priming material 40 comprises 60-95% of the total mass of the viscous priming material 40.

A third step of a method for priming a substrate in accordance with the present invention may comprise applying the viscous priming material 40 to at least a portion of the substrate 74. Referring now to FIG. 5, certain embodiments of the present invention include providing a priming device 80 to facilitate automatic application of the priming material to the substrate. As discussed above with reference to FIG. 3, a priming device may include an opening substantially mirroring the cross-sectional profile of the substrate such that the substrate may pass through the priming device and become coated thereby. A next step may include introducing the substrate into the priming device 82, and then advancing the substrate therethrough 84. As the substrate is advanced through the priming device, the viscous priming materials 40 is deposited thereon 86. Alternatively, the method may include manually applying the priming material to the substrate, or using other means or devices known to those in the art.

A fourth step for priming a substrate in accordance with certain embodiments of a method of the present invention comprises removing excess priming material from the substrate 76. Where a priming device is implemented as discussed above and with respect to FIG. 3, an opening 52 in the priming device 50 may function to remove excess priming material 40 as the substrate 20 passes therethrough. Alternatively, an excess of priming material 40 may be removed manually, or by other automated means known to those in the art.

A fifth step of a method for priming a substrate in accordance with the present invention may comprise evaporating the volatile component from the viscous priming material 40 that has been applied 78, such that the primed substrate 60 can be placed in a stack 62 without damage to the smooth surface formed by the present method.

What is claimed is:

1. A method for priming a substrate to receive a decoration, said method comprising:
providing a dimensioned, substantially rigid substrate;
providing a substantially cold-setting viscous priming material comprising a filler and a volatile component, where said filler comprises between sixty and ninety-five percent solid material by mass;
applying said substantially cold-setting viscous priming material to at least a portion of said substrate under substantially ambient conditions; and
removing an excess of said substantially cold-setting viscous priming material from said portion of said substrate such that said viscous priming material is substantially evenly distributed over said portion of said substrate.

2. The method of claim 1, wherein said applying said substantially cold-setting viscous priming material to said portion of said substrate:
providing a priming device having an opening substantially corresponding to a cross-sectional profile of said substrate;
introducing said substrate into said opening; and
advancing said substrate through said priming device to prime at least a portion of said substrate with said substantially cold-setting viscous priming material.

3. The method of claim 1, wherein said substrate is selected from the group consisting of a window molding, a door molding, a crown molding, a baseboard, a chair rail, a staircase railing, and a mantle.

4. The method of claim 1, wherein said substrate comprises a solid wood substitute selected from the group consisting of finger-jointed wood, plywood, particle board, light density fiberboard, medium density fiberboard, high density fiberboard, plastic/wood composite, cement board, flake board, wafer board and chip board.

5. The method of claim 1, wherein said filler is selected from the group consisting of acetyl, acrylic, polyester, polycarbonate, polypropylene, polyethylene, polystyrene, polyurea, a thermoplastic elastomer, a vinyl alloy, urea formaldehyde, melamine formaldehyde, polyvinyl acetate, aliphatic resin glue, polyurethane glue, epoxy resin, lime, carbon black, talc, kolin, wood dust, fly ash, and diatomaceous earth.

6. The method of claim 1, wherein said volatile component is selected from the group consisting of acetone, alcohol, benzene, epichlorohydrin, esters, gasoline, glycol ethers, heptane, hexane, kerosene, ketones, methanol, methylene chloride, mineral spirits, naphtha, toluene, trichloroethane, turpentine, xylene, and water.

7. The method of claim 1, wherein said substantially cold-setting viscous material further comprises an additive.

8. The method of claim 7, wherein said additive is selected from the group consisting of pigments, scents, stabilizers, flame retardants, anti-oxidants and anti-fungals.

9. A method for priming a substrate to receive a decoration, comprising:
providing a dimensioned, substantially rigid substrate comprising a solid wood substitute
having at least one decoratable surface;
providing a substantially cold-setting viscous priming material comprising a filler and a volatile component, where said filler comprises between sixty and ninety-five percent solid material by mass;
applying said substantially cold-setting viscous priming material to at least a portion of said at least one decoratable surface under substantially ambient conditions; and
removing an excess of said substantially cold-setting viscous priming material from said portion of said at least one decoratable surface such that said viscous priming material is substantially evenly distributed over said portion of said decoratable surface.

10. The method of claim 9, wherein said applying said substantially cold-setting viscous priming material to said at least one decoratable surface further comprises:
providing a priming device having an opening substantially corresponding to a cross-sectional profile of said substantially rigid substrate;
introducing said substantially rigid substrate into said opening; and
advancing said substantially rigid substrate through said priming device to prime at least a portion of said at least one decoratable surface with said substantially cold-setting viscous priming material.

11. The method of claim 9, wherein said percent solid material by mass of said filler is in a range between about 60 and 70.

12. The method of claim 9, wherein said percent solid material by mass of said filler is in a range between about 70 and 80.

13. The method of claim 9, wherein said percent solid material by mass of said filler is in a range between about 80 and 90.

14. The method of claim 9, wherein said percent solid material by mass of said filler is in a range between about 90 and 95.

15. An article of manufacture comprising a dimensioned, substantially rigid substrate, said substrate comprising a solid wood substitute having at least one decoratable surface, at least a portion of said at least one decoratable surface having a cold-setting viscous priming material applied thereto, said cold-setting viscous priming material comprising a filler in a range between sixty and ninety-five percent of a total composition mass, and a volatile component.
